(19) United States
(12) Patent Application Publication
(10) Pub. No.: US 2006/0188286 A1
(43) Pub. Date: Aug. 24, 2006

(54) Blade-cleaning device and blade member supporting method

(75) Inventor: Keiji Yuge, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/064,513

(22) Filed: Feb. 24, 2005

(51) Int. Cl. G03G 21/00

(52) U.S. Cl. 399/102; 399/350; 399/351

(57) ABSTRACT

A blade cleaning device of the present invention fixes a blade to a blade support member in a state of sliding and moving it in the longitudinal direction and fixes a second side seal member to the blade support member in a state of sliding and moving it in the longitudinal direction on the second side of the blade support member. By doing this, even if the dimensional tolerance limits of the blade are varied, the gap between the blade support member and the blade member can be sealed surely, and the manufacturing accuracy of the blade as a change part is moderated, and the yield rate of defective products is improved.

### BACKGROUND OF THE INVENTION

1. Field of the Invention

The present invention relates to a blade cleaning device for cleaning an image carrying member of an image forming apparatus such as a copier or a printer by a blade and a blade member supporting method.

2. Description of the Related Art

In an image forming apparatus such as an electro-photographic copier, a printer, or a multifunction peripheral (hereinafter abbreviated to MFP), a blade cleaning device for sliding a blade in contact with a drum-shaped or belt-shaped photoconductor or an intermediate transfer medium after transfer to collect and remove remaining toner may be used. In such a blade cleaning device, toner collected by the blade may leak from both sides of the blade in the longitudinal direction.

Therefore, conventionally, in Japanese Patent Application Publication No. 7-5794, a cleaning device having side seals installed on both sides of a cleaning blade is disclosed.

In the aforementioned conventional cleaning device, using one end of the blade as a position reference, at the end opposite to it, the attaching position of a side seal positioning member is adjusted, and a side seal attached to a side seal support member and the blade are adjusted in the position. Namely, in the conventional cleaning device, for the blade at the time of exchange, on the assumption that the dimensional tolerance limits are the same, the position adjustment between the side seal and the blade is limited to the adjustment range of the side seal positioning member.

However, for a blade for a cleaning device which is mainly made of polyurethane rubber, it is difficult to produce a large amount of blades with high precision of the positions of both sides thereof and the dimensional tolerance limits of blades to be used for exchange are varied easily. Nevertheless, in the conventional cleaning device, since the dimensional tolerance limits of blades must be the same, the yield rate of defective blades for exchange decreases.

Therefore, a blade cleaning device and a blade member supporting method in which even if the dimensional tolerance limits of blades are varied, the position relationship between the side seals and the blade can be adjusted, and blades can be used for exchange, and the yield rate of defective blades is improved are desired.

### SUMMARY OF THE INVENTION

An object of an embodiment of the present invention, in a blade cleaning device, is to enable use as blades for exchange even if the dimensional tolerance limits of blades are varied, prevent collected toner from leakage, and improve the yield rate of defective blades.

According to the embodiment of the present invention, there is provided a blade cleaning device comprising a blade support member having a fist side and a second side opposite to the first side; a blade member fixed to the blade support member so as to slide and move in a longitudinal direction to clean toner on an image carrying member; a fist side seal member installed in the blade support member in a state of striking against the blade member on the first side to seal a gap between the blade member and the blade support member; and a second side seal member fixed to the blade support member in a state of striking against the blade member on the second side so as to slide and move in the longitudinal direction of the blade member to seal the gap between the blade member and the blade support member.

### BRIEF DESCRIPTION OF THE DRAWINGS

FIG. 1 is a schematic block diagram showing an image forming unit of an image forming apparatus loading the blade cleaning device of the embodiment of the present invention;

FIG. 2 is a plan view showing the blade cleaning device and photosensitive drum of the embodiment of the present invention;

FIG. 3 is a plan view showing the blade cleaning device before attaching the blade mold of the embodiment of the present invention;

FIG. 4 is a plan view showing the blade mold of the embodiment of the present invention;

FIG. 5 is a schematic side view showing the blade mold of the embodiment of the present invention;

FIG. 6 is a perspective view showing the side seal bracket of the embodiment of the present invention;

FIG. 7 is a plan view showing the blade cleaning device when the side seal bracket of the embodiment of the present invention is set;

FIG. 8 is a plan view showing the blade cleaning device when the blade mold of the embodiment of the present invention is attached;

FIG. 9 is a cross sectional view on the line A-A′ in FIG. 8 showing the blade cleaning device when the blade mold of the embodiment of the present invention is attached; and

FIG. 10 is a cross sectional view on the line B-B′ in FIG. 8 showing the blade cleaning device when the blade mold of the embodiment of the present invention is attached.

### DETAILED DESCRIPTION OF THE INVENTION

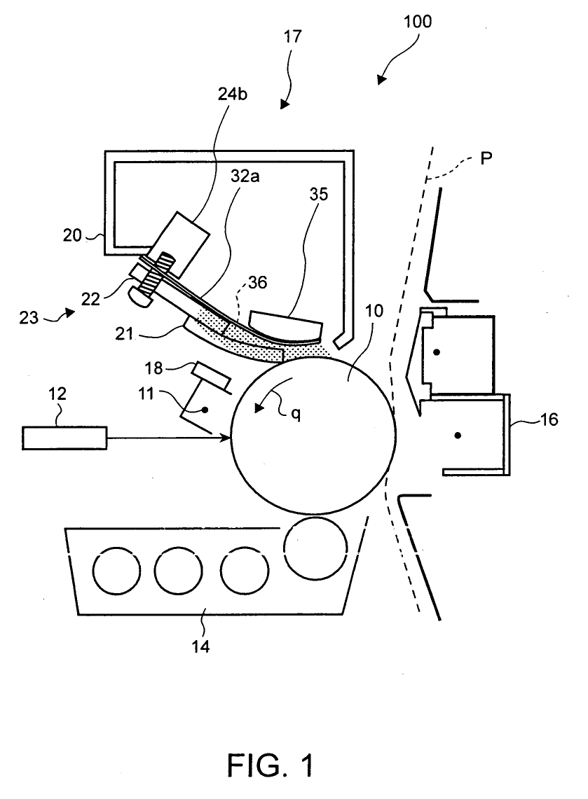

Hereinafter, the embodiment of the present invention will be explained in detail with reference to the accompanying drawings. FIG. 1 is a schematic block diagram showing image forming unit 100 of an image forming apparatus of an electro-photographic type such as a copier or a printer loading the blade cleaning device of the embodiment of the present invention. Around photosensitive drum 10 which is an image carrying member rotated in the direction of arrow q, in the rotational direction thereof, charger 11, laser exposure unit 12 for forming a latent image on charged photosensitive drum 10 on the basis of image data, developing units 14, transfer-separation charger 16, blade cleaning device 17, and discharging unit 18 are arranged sequentially.

In image forming unit 100, when the image forming process is started, photosensitive drum 10 is rotated in the direction of arrow q. By doing this, photosensitive drum 10 is uniformly charged by charger 11 and then is irradiated a laser beam according to image data by laser exposure unit 12, thus an electrostatic latent image is formed. Then, the electrostatic latent image on photosensitive drum 10 is developed by developing unit 14 and is transferred to transfer paper P by transfer-separation charger 16. Thereafter, transfer paper P is separated from photosensitive drum 10 and passes the fixing step and a toner image is completed. On the other hand, after separation of transfer paper P, photosensitive drum 10 is cleaned residual toner by blade cleaning device 17, is removed residual charge by discharging unit 18, and waits for the next image forming process.

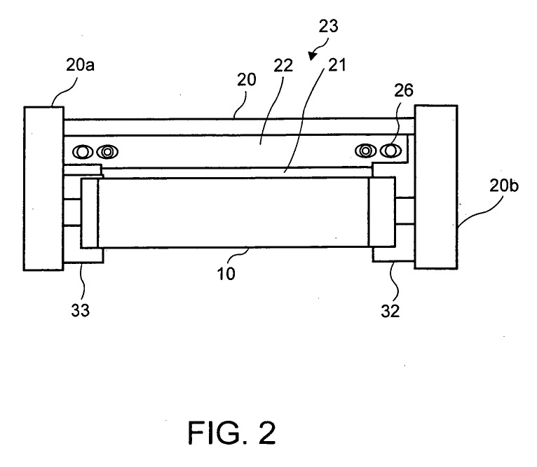

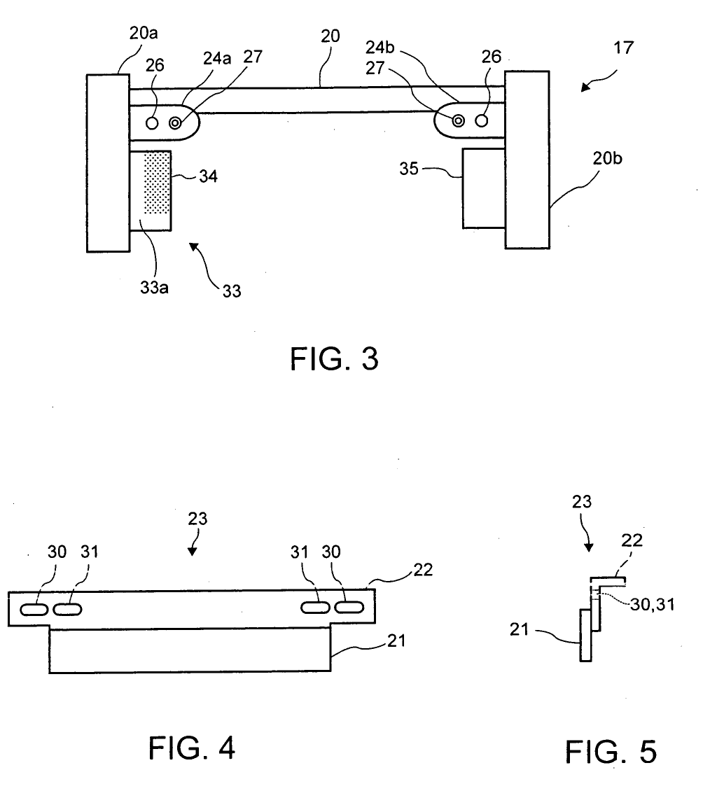

Next, blade cleaning device 17 will be described in detail. As shown in FIGS. 2 and 3, first and second side frames 20a and 20b of cleaner mold 20 constituting the blade support member of blade cleaning device 17 fix and support photosensitive drum 10 together with blade 21 constituting the blade member. By doing this, photosensitive drum 10 and blade 21 are arranged with high precision and at the time of the image forming process, blade 21 slides on the surface of photosensitive drum 10 in contact with it at a predetermined contact pressure and removes residual toner adhered to photosensitive drum 10 after transfer.

Blade mold 23 which is a blade member, as shown in FIGS. 4 and 5, is formed by adhering blade 21 made of polyurethane rubber to blade attaching plate 22 made of a metal. In blade attaching plate 22, blade boss slots 30 and blade screw slots 31 are formed in the longitudinal direction of blade 21. Blade 21, since blade attaching plate 22 is attached to blade fixing molds 24a and 24b on the first and second sides constituting the blade support member formed on frames 20a and 20b shown in FIG. 3, is positioned to photosensitive drum 10 with high precision.

As shown in FIG. 3, first and second side blade fixing molds 24a and 24b are respectively united with first and second side frames 20a and 20b. In blade fixing molds 24a and 24b, threaded holes 27 for screwing bosses 26 for guiding blade boss slots 30 and blade attaching plate 22 in order to slide blade attaching plate 22 in the longitudinal direction are formed. By screws 28 which are fixing members, to first side blade fixing mold 24a, blade attaching blade 22 is directly attached.

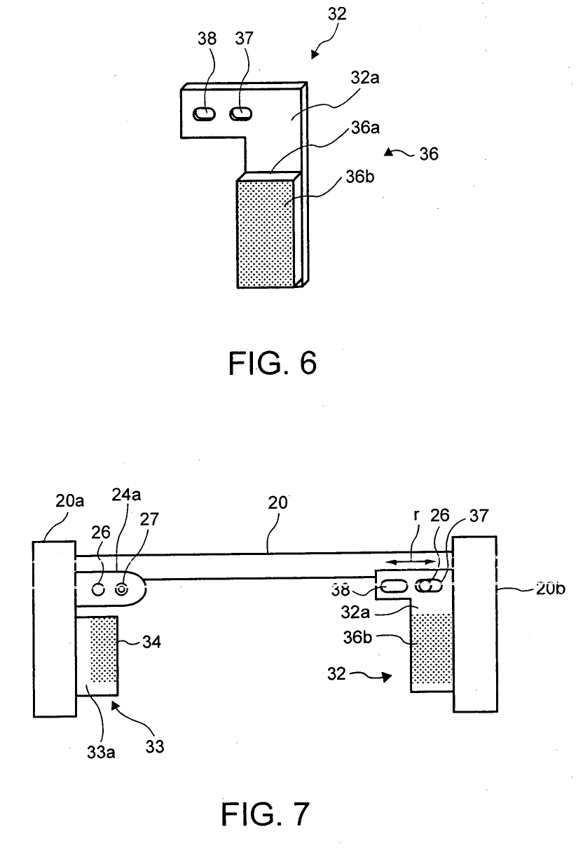

As shown in FIGS. 6 to 9, to second side blade fixing mold 24b, blade attaching plate 22 is attached by screws 28 via side seal bracket 32 which is a second side seal member for sealing between blade 21 and second side frame 20b. Namely, as shown in FIG. 9, seal support sheet 32a of side seal bracket 32 is fixed while holding between blade attaching plate 22 and blade fixing mold 24b.

Second side blade fixing mold 24b is formed so that the surface thickness thereof, assuming the thickness of seal support sheet 32a of side seal bracket 32 as ∂, compared with the surface height of first side blade fixing mold 24a, is made smaller by the thickness α of seal support sheet 32a. By doing this, blade 21 slides in contact with photosensitive drum 10 in parallel.

On first side frame 20a, side seal mold 33 constituting the blade support member is formed. Side seal mold 33 is formed by adhering first seal 34, which is a first side seal member, composed of a felt layer formed on an elastic body made of boron (B) for sealing between blade 21 and first side frame 20a onto side seal adhering face 33a. The felt layer of first seal 34 is in contact with the surface of photosensitive drum 10.

As shown in FIG. 10, in second side frame 20b, support mold 35 constituting the blade support member for supporting the rear of side seal bracket 32 is formed. Side seal bracket 32, as shown in FIG. 6, is formed by adhering second seal 36, which is the second seal member for sealing between blade 21 and second side frame 20b, onto seal support sheet 32a. Second seal 36 is formed by forming felt layer 36b on elastic body 36a made of boron (B). In seal support sheet 32a, seal boss slot 37 and seal screw slot 38 parallel with the longitudinal direction of blade 21 are formed. Side seal bracket 32 is guided by boss 26 on second side blade fixing mold 24b which is inserted through seal boss slot 37 and can move by sliding in the longitudinal direction of blade 21. When side seal bracket 32 is screwed to second side blade fixing mold 24b together with blade attaching plate 22, by supporting from the rear by support mold 35, felt layer 36b of second seal 36 is in contact with the surface of photosensitive drum 10 at an appropriate pressure.

Next, in such blade cleaning device 17, at the time of exchange of blade 21 for maintenance, a process of attaching blade 21 to cleaner mold 20 will be described. As shown in FIG. 3, when photosensitive drum 10 is removed, as shown in FIG. 7, boss 26 on second side blade fixing mold 24b is inserted through seal boss slot 37 of seal support sheet 32a and side seal bracket 32 is set on second side blade fixing mold 24b. Then, bosses 26 on first and second side blade fixing molds 24a and 24b are inserted through blade boss slots 30 of blade attaching plate 22.

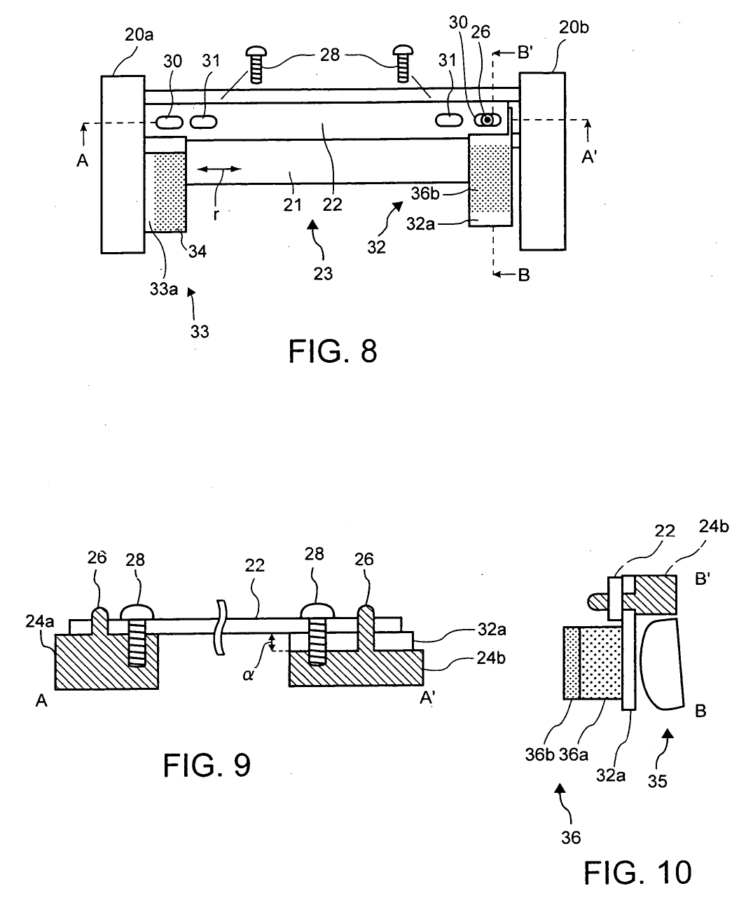

Furthermore, as shown in FIGS. 7 and 8, depending on the length of blade 21 which is a change part, blade attaching plate 22 is slid and adjusted in the longitudinal direction indicated by arrow r, and blade 21 strikes against first seal 34, and blade attaching plate 22 is screwed by screw 28 and is fixed to first side blade fixing mold 24a. Then, side seal bracket 32 is slid and adjusted in the direction of arrow r, and second seal 36 strikes against blade 21, and side seal bracket 32 and blade attaching plate 22 are stacked up, are screwed together by screw 28, and are fixed to second side blade fixing mold 24b. Hereafter, photosensitive drum 10 is attached to first and second side frames 20a and 20b of cleaner mold 20.

In blade cleaning device 17 formed in this way, since blade 21 is made of polyurethane rubber, the position accuracy of both sides can be hardly obtained at the time of manufacture, and even when the dimensional tolerance limits of the blade are not the same, the gap between blade 21 and first or second side frame 20a or 20b is blocked surely respectively by first seal 3 or second seal 36.

Namely, for example, even if the length of whole blade 21 prepared as a change part is slightly long or short and moreover the first or second side length of blade 21 is different, for first and second blade fixing molds 24a and 24b, blade attaching plate 22 is slid and adjusted in the direction of arrow r, thus blade 21 surely strikes against first seal 34, and the gap between blade 21 and first frame 20a can be sealed surely. Furthermore, seal support sheet 32a is slid and adjusted in the direction of arrow r for second side blade fixing mold 24b, thus second seal 36 surely strikes against blade 21, and the gap between blade 21 and second frame 20b can be sealed surely.

Therefore, even if the dimensional tolerance limits of blade 21 as a change part are not the same, residual toner collected by blade 21 in blade cleaning device 17 at the time of the image forming process by image forming unit 100 is prevented from leakage from the gap between blade 21 and first or second side frame 20a or 20b of cleaner mold 20.

According to this embodiment, even if the dimensional tolerance limits of blade 21 are large at the time of exchange of blade 21 in blade cleaning device 17, on both sides of blade 21, the gap between blade 21 and first or second frame 20a or 20b can be surely sealed by first seal 34 or second seal 36 and residual toner collected by blade cleaning device 17 is prevented from leakage from the gap between blade 21 and first or second side frame 20a or 20b. Therefore, blade 21 which is a change part, even if the dimensional tolerance limits thereof are slightly wider, can be used and the yield rate of defective products due to moderation of the manufacture accuracy of blade 21 as a change part can be improved.

Further, first and second side blade fixing molds 24a and 24b are respectively united with first and second side frames 20a and 20b, so that at the time of exchange of blade 21, the number of parts to be mounted or demounted on cleaner mold 20 can be reduced, and the maintenance operation can be performed easily, and the exchange time of blade 21 can be shortened. Further, the exchange operation of blade 21 includes just to slide and move blade attaching plate 22 or seal support sheet 32a to a desired position while guiding it by boss 26 and then screw blade attaching plate 22 or seal support sheet 32a to first or second side blade fixing mold 24a or 24b by screw 28, thus blade 21 can be exchanged easily.

Further, compared with the surface height to the surface of photosensitive drum 10 of first side blade fixing mold 24a, the surface height to the surface of photosensitive drum 10 of second side blade fixing mold 24b is lower by the thickness of blade attaching plate 22. Therefore, although seal support sheet 32a and blade attaching plate 22 are overlaid with second side blade fixing mold 24b and are screwed together by the same screws 28, blade 21 can slide in contact with photosensitive drum 10 in parallel.

Further, side seal bracket 32 fixes seal support sheet 32a while holding it between blade attaching plate 22 and blade fixing mold 24b, so that it is strong and moreover can prevent toner from leaking from the joined part.

Further, the present invention is not limited to the aforementioned embodiment and within the scope of the present invention, can be modified variously, and for example, the image carrying member may be a belt-shaped photoconductor or an intermediate transfer medium. Further, the dimensional tolerance limits of the blade as a change part, as long as the limits can be covered by slide movement of the blade support plate and slide movement of the side seal means, are not limited.

As described above in detail, according to the present invention, even if the dimensional tolerance limits of the blade are varied, the blade member is fixed in a state that it strikes against the first side seal member, and the second side seal member is fixed in a state that it strikes against the blade member, thus the gap between the blade member and the blade support member can be sealed surely. Therefore, the manufacture accuracy of the blade member as a change part can be moderated and the yield rate of defective products can be improved. Further, the second side seal member is fixed while holding it between the blade support member and the blade member, so that the second side seal member becomes strong and furthermore toner can be prevented from leaking from the joined part.

What is claimed is:

1. A blade cleaning device comprising:
a blade support member which has a fist side and a second side opposite to the first side;
a blade member fixed to the blade support member so as to slide and move in a longitudinal direction to clean toner on an image carrying member;
a fist side seal member installed in the blade support member in a state of striking against the blade member on the first side to seal a gap between the blade member and the blade support member; and
a second side seal member fixed to the blade support member in a state of striking against the blade member on the second side so as to slide and move in the longitudinal direction of the blade member to seal the gap between the blade member and the blade support member.

2. The blade cleaning device according to claim 1, wherein the blade member and the second side seal member are overlaid on the blade support member and are together attached to the blade support member by the same fixing member.

3. The blade cleaning device according to claim 2, wherein the blade member and the second side seal member are overlaid and fixed together onto the blade support member in order of the second side seal member and the blade member.

4. The blade cleaning device according to claim 3, wherein assuming a thickness of the second side seal member as α, compared with a height of a support face of the first side blade support member, a height of a support face of the second side blade support member is set lower by the thickness α.

5. The blade cleaning device according to claim 1, wherein:
the blade support member has a screw hole and a boss;
the blade member has a blade boss slot parallel to the longitudinal direction through which the boss is inserted and a blade screw slot for screwing;
the second side seal member has a seal boss slot parallel to the longitudinal direction through which the boss is inserted and a seal screw slot for screwing;
the blade member is guided by the blade boss slot through which the boss is inserted and slides and moves in the longitudinal direction; and
the second side seal member is guided by the seal boss slot through which the boss is inserted and slides and moves in the longitudinal direction.

6. The blade cleaning device according to claim 5, wherein:
the bosses on the blade support member inserted through the blade boss slot of the blade member and the seal boss slot of the second side seal member are the same; and
the same screw is inserted through the blade screw slot of the blade member and the seal screw slot of the second side seal member and the blade member and the second side seal member are together screwed to the blade support member by the same screw.

7. The blade cleaning device according to claim 6, wherein the second side seal member and the blade member are overlaid on the blade support member in order of the second side seal member and the blade member and are together screwed by the same screw.

8. The blade cleaning device according to claim 7, wherein assuming a thickness of the second side seal member as α, compared with a height of a support face of the first side blade support member, a height of a support face of the second side blade support member is set lower by the thickness α.

9. A blade cleaning device comprising:
blade support means for being provided a first side and a second side opposite to the first side;
blade means fixed to the blade support means so as to slide and move in a longitudinal direction for cleaning toner on an image carrying member;
fist side seal means installed in the blade support means in a state of striking against the blade means on the first side for sealing a gap between the blade means and the blade support means; and
second side seal means fixed to the blade support means in a state of striking against the blade means on the second side so as to slide and move in the longitudinal direction of the blade means for sealing the gap between the blade means and the blade support means.

10. The blade cleaning device according to claim 9, wherein the blade means and the second side seal means are overlaid on the blade support means and are together attached to the blade support means by a same fixing member.

11. The blade cleaning device according to claim 10, wherein the blade means and the second side seal means are overlaid together on the blade support means in order of the second side seal means and the blade means and are fixed together.

12. The blade cleaning device according to claim 11, wherein assuming a thickness of the second side seal means as α, compared with a height of a support face of the first side blade support means, a height of a support face of the second side blade support means is set lower by the thickness α.

13. The blade cleaning device according to claim 9, wherein:
the blade support means has a screw hole and a boss;
the blade means has a blade boss slot parallel to the longitudinal direction through which the boss is inserted and a blade screw slot for screwing;
the second side seal means has a seal boss slot parallel to the longitudinal direction through which the boss is inserted and a seal screw slot for screwing;
the blade means is guided by the blade boss slot through which the boss is inserted and slides and moves in the longitudinal direction; and
the second side seal means is guided by the seal boss slot through which the boss is inserted and slides and moves in the longitudinal direction.

14. The blade cleaning device according to claim 13, wherein:
the bosses on the blade support means inserted through the blade boss slot of the blade means and the seal boss slot of the second side seal means are the same; and
the same screw is inserted through the blade screw slot of the blade means and the seal screw slot of the second side seal means and the blade means and the second side seal means are together screwed to the blade support means by the same screw.

15. The blade cleaning device according to claim 14, wherein the second side seal means and the blade means are overlaid on the blade support means in order of the second side seal means and the blade means and are together screwed by the same screw.

16. The blade cleaning device according to claim 15, wherein assuming a thickness of the second side seal means as α, compared with a height of a support face of the first side blade support means, a height of a support face of the second side blade support means is set lower by the thickness α.

17. The blade cleaning device according to claim 13, wherein:
the blade means is composed of a blade sliding in contact with the image carrying member and a blade support plate for attaching and supporting the blade; and
in the blade support plate, the blade boss slot and the blade screw slot are formed.

18. The blade cleaning device according to claim 13, wherein:
the second side seal means is composed of a seal support sheet and an elastic seal material installed in the seal support sheet; and
in the blade support plate, the blade boss slot and the blade screw slot are formed.

19. A blade member support method comprising:
striking a blade member against a first side seal member to seal a gap between the blade member provided on a first side of a blade support member to clean toner on an image carrying member and the blade support member;
striking a second side seal member against the blade support member on a second side of the blade support member to seal a gap between the blade member and the blade support member; and
fixing the second seal member to the blade support member.

20. The blade member support method according to claim 19, wherein the fixing includes overlaying the blade member and the second side seal member on the blade support member and fixing them together to the blade support member by a same fixing member.
